(19) United States
(12) Patent Application Publication
(10) Pub. No.: US 2007/0107500 A1
(43) Pub. Date: May 17, 2007

(54) Sensing moisture uptake of package polymers

(76) Inventor: Neha Patel, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/281,271

(22) Filed: Nov. 16, 2005

(51) Int. Cl. G01N 5/02; G01N 27/22

(52) U.S. Cl. 73/73; 73/335.04

(57) ABSTRACT

An embodiment of the present invention is a technique to sense moisture uptake of package polymers in humid environment. A capacitor is formed in a semiconductor package having a capacitance changing according to a real-time moisture adsorption in the package. A capacitance circuit provides measurement of the capacitance of the capacitor corresponding to an in-situ measurement of the moisture adsorption.

### BACKGROUND

1. Field of the Invention

Embodiments of the invention relate to the field of semiconductor manufacturing and packaging, and more specifically, to moisture sensing.

2. Description of Related Art

Testing packaged semiconductor devices provides useful information on various failure modes. Highly Accelerated Stress Test (HAST) exposes the packages to extreme environmental conditions such as high temperature and relative humidity. Biased-HAST exposes the packages to the same environmental conditions while the devices are being powered. Under these extreme conditions, packaged devices may fail due to several reasons. One of the important causes of failures is the loss of polymeric adhesion which may affect interfaces between polymeric adhesives or encapsulants and other package components such as solder interconnects, chip passivation, heat sinks, and chip carrier surfaces.

It is useful to correlate the observed failures to the material properties of the polymer used in the package. Current testing methods do not provide in-situ moisture uptake of packaged polymers. Existing techniques provide readouts of test data after 25 to 100 hours of exposure to HAST or biased-HAST. There is no known method to know at what point the failures initiate in a moisture environment.

### BRIEF DESCRIPTION OF THE DRAWINGS

Embodiments of invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating a moisture chamber according to one embodiment of the invention.

FIG. 3 is a diagram illustrating a humidity sensor according to one embodiment of the invention.

FIG. 4 is a flowchart illustrating a process to sense moisture uptake according to one embodiment of the invention.

FIG. 5 is a flowchart illustrating a process to form a capacitor according to one embodiment of the invention.

FIG. 6 is a diagram illustrating a circuit having a capacitor according to one embodiment of the invention.

### DESCRIPTION

An embodiment of the present invention is a technique to sense moisture uptake of package polymers in a humid environment. A capacitor is formed in a semiconductor package having a capacitance changing according to a real-time moisture adsorption in the package. A capacitance circuit provides measurement of the capacitance of the capacitor corresponding to an in-situ measurement of the moisture adsorption.

In the following description, numerous specific details are set forth. However, it is understood that embodiments of the invention may be practiced without these specific details. In other instances, well-known circuits, structures, and techniques have not been shown to avoid obscuring the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

One embodiment of the invention is a technique to sense or measure moisture uptake of package polymers using a capacitive detection technique to characterize the moisture uptake during a stress test. The moisture sensor is placed at a strategic location in the die of the package. Various types of failure may occur during a moisture test. For example, when a polymer dielectric is saturated, it may de-bond from the metal interface that may lead to stress at the underlying metal layers. This increased stress may cause an electrical or inter-level dielectric failure. The continuous monitoring of the electrical signal from the moisture sensor allows a determination of when the polymer material in the package begins to saturate. This determination allows using an appropriate theoretical model to predict performance of the device. The moisture information obtained by the moisture or humidity sensor may also be used to correlate with the time-to-electrical fail rate of the packaged parts after exposure to an accelerated stress test, thermal cycling, or pre-conditioning test, or even after assembly tests which may involve acoustic imaging of parts under water.

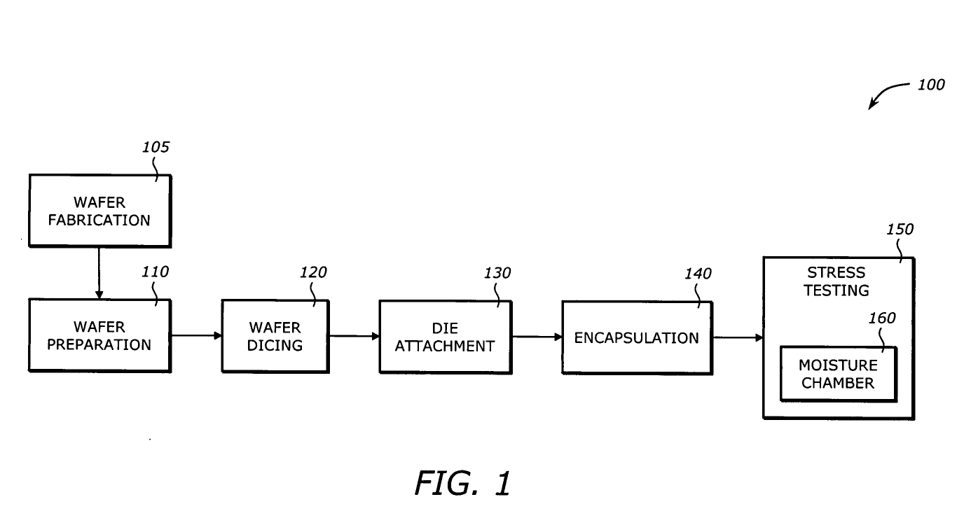

FIG. 1A is a diagram illustrating a system 100 in which one embodiment of the invention can be practiced. The system 100 includes a wafer fabrication phase 105, wafer preparation phase 110, a wafer dicing phase 120, a die attachment phase 130, an encapsulation phase 140, and a stress testing phase 150. The system 100 represents a manufacturing flow of a semiconductor packaging process.

The wafer fabrication phase 105 fabricates the wafer containing a number of dice. The individual dice may be any microelectronic devices such as microprocessors, memory devices, interface circuits, etc. Each die contain a humidity sensor to sense the humidity level of the environment in the testing phase. The wafer fabrication phase 105 includes typical processes for semiconductor fabrication such as preparation of the wafer surface, growth of silicon dioxide (SiO₂), patterning and subsequent implantation or diffusion of dopants to obtain the desired electrical properties, growth or deposition of a gate dielectric, and growth or deposition of insulating materials, depositing layers of metal and insulating material and etching it into the desired patterns. Typically the metal layers consist of aluminium or more recently copper. The various metal layers are interconnected by etching holes, called “vias,” in the insulating material. During this phase, one or more humidity sensors are strategically fabricated in each die together with the fabrication process for the circuit of the device.

The wafer preparation phase 110 prepares a wafer containing dice for packaging and testing. During this phase, the wafers are sorted after the patterning process. An inspection may be carried out to check for wafer defects. Then, the wafer may be mounted on a backing tape that adheres to the back of the wafer. The mounting tape provides mechanical support for handling during subsequent phases.

The wafer dicing phase 120 dices, cuts, or saws the wafer into individual dice. High precision saw blade and image recognition unit may be used. De-ionized water may be dispensed on the wafer to wash away any residual particles or contaminants during the dicing. Then, the wafer is dried by being spun at high spinning speed.

The die attachment phase 130 attaches the die to a package substrate. The substrate material depends on the packaging type. It may be lead-frame, plastic, or epoxy.

The encapsulation phase 140 encapsulates the die and the substrate. Depending on the packaging type, this may include molding, wire bonding, and solder ball attachment. Underfill material may be dispensed between the die and the substrate. Integrated heat spreader (IHS) may be attached to the die and substrate assembly. The encapsulated assembly of the die and substrate becomes a package ready to be tested.

The stress testing phase 150 performs one or more tests such as HAST or biased-HAST on the package under stress conditions. In one of the tests, the package is placed in a moisture chamber 160 to provide a humid environment. The package may be powered or non-powered. The package contains an integrated humidity sensor to provide in-situ measurement of the humidity level in the moisture chamber.

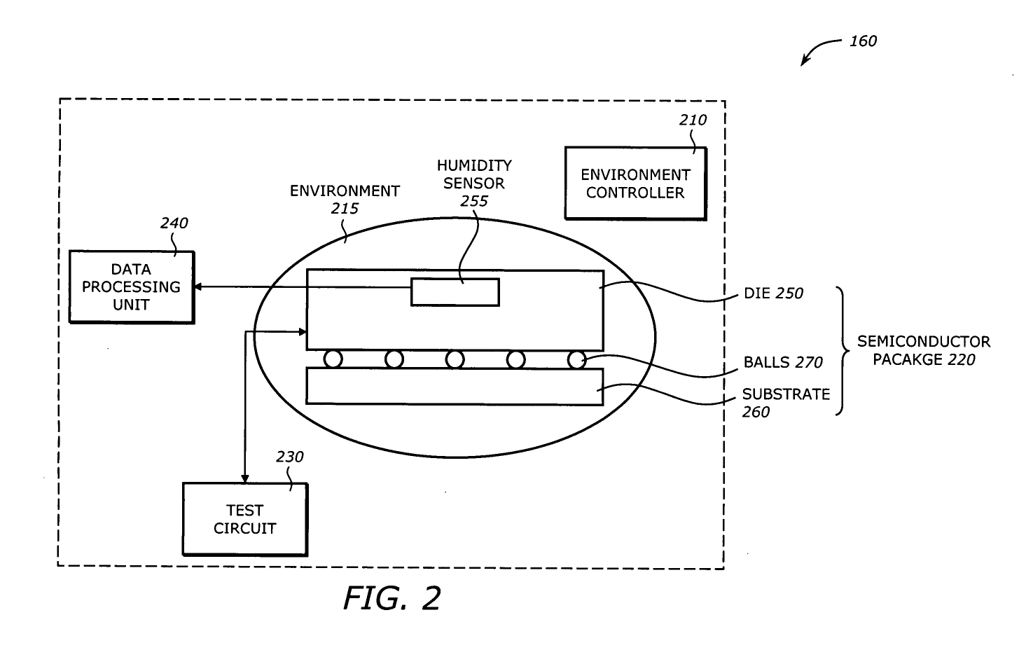

FIG. 2 is a diagram illustrating the moisture chamber 160 shown in FIG. 1 according to one embodiment of the invention. The moisture chamber 160 includes an environmental controller 210, a semiconductor package 220, a test circuit 230, and a data processing unit 240. The moisture chamber 160 may include more or less components than the above. In addition, any one of the environment controller 210, the test circuit 230, and the data processing unit 240 may be located outside of the moisture chamber 160.

The environment controller 210 controls the conditions of an environment 215 surrounding the package 220 in the moisture chamber 160. The environmental conditions may include temperature, humidity, or any other environmental test parameters. The environment controller 210 may provide a relative humidity (RH) level in the moisture chamber 160 from 0% to 100%. Typically, the relative humidity may range from 70% to 90%. In one embodiment, the stress test is a highly accelerated stress test (HAST). Under the HAST, the package 220 may be exposed to an environment having a temperature of approximately 130° C. and a RH level of approximately 85%.

The package 220 is the device under test exposed to the environment 215. It may include a die 250, a substrate 260 and solder balls 270. The die 250 may include an embedded humidity sensor 255. The humidity sensor 255 in internal to the die 250 and senses the moisture uptake of polymers in the package 220 during the real-time moisture test. There may be several humidity sensors similar to the humidity sensor 255 located at various locations inside the package 220. The humidity sensor 255 may be located at a strategic location inside the die 250. It may be located at the center or corners of the die 250. Several humidity sensors like the humidity sensor 255 may be spread over an area that corresponds to an even distribution of moisture uptake in the die 250.

The test circuit 230 includes circuitry that provides testing parameters to the package 220. It may include power on/off control, current injection, and voltage application. It may have probes or leads that connected to the package 220 at appropriate test points. It may interface to an automatic test equipment located externally to the moisture chamber 160.

The data processing unit 240 processes the data obtained from the package 220. It may be integrated to the test circuit 230 or it may operate in a stand-alone mode. It may include other environmental sensors such as a temperature sensor to monitor the environmental conditions inside the moisture chamber 160. The data collected may include the humidity level sensed by the humidity sensor 255, time, temperature, currents, voltages, or any other test data that are available for collection in real-time. When the humidity sensor 255 uses an external capacitance measurement as will be discussed later, the data processing unit 240 may also include a capacitance measuring circuit to measure the capacitance embedded in the package 220. The data processing unit 240 may include storage device to store the data in real-time.

The data collected by the data processing unit 240 may be correlated with the failures of the package 220 during the test so that models may be constructed to predict performance of the device. In addition, analysis of the data may reveal failure characteristic of polymers inside the package 220.

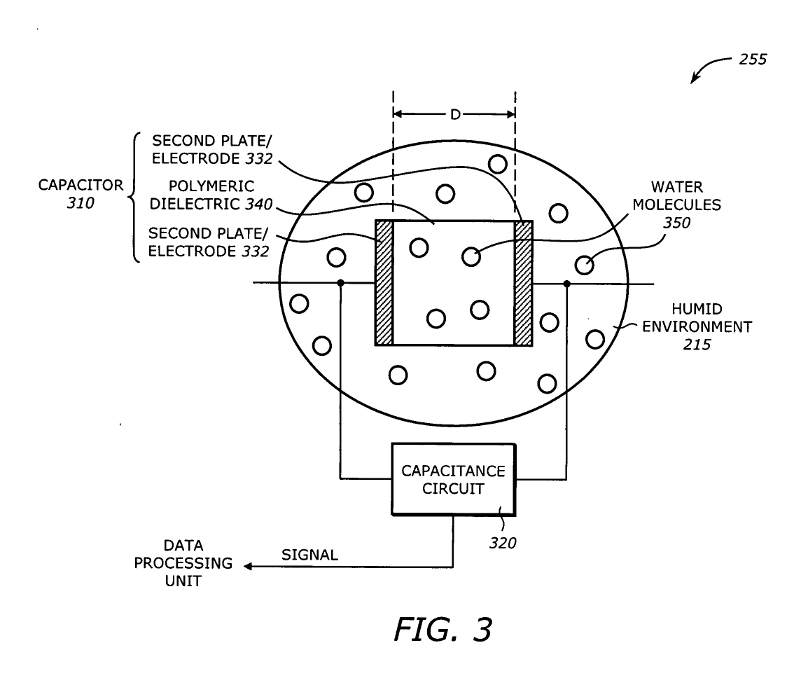

FIG. 3 is a diagram illustrating the humidity sensor 255 shown in FIG. 2 according to one embodiment of the invention. The humidity sensor 255 includes a capacitor 310 and a capacitance circuit 320.

The capacitor 310 is formed inside the package 220, or the die 250. It has a capacitance that changes according to a real-time moisture adsorption in the package 220 or the die 250. The moisture adsorption corresponding to a humidity level surrounding the package 220 or internal to the die 250. It may include two metal plates or lines 330 and 332 and a polymeric dielectric 340. The two plates 330 and 332 are typically in parallel and placed at a distance D apart. In one embodiment, they may have approximately equal dimensions. The polymeric dielectric 340 is a dielectric layer embedded within the two metal plates or lines 330 and 332. The polymeric dielectric 340 has a dielectric constant changing according to density of water molecules 350 generated from the moisture adsorption.

The change in the capacitance of the capacitor 310 varies according to the change in the dielectric constant of the polymeric dielectric 340 as given in the following equation:
ΔC=ε₀A Δε/D (1)

where ΔC is the change in capacitance during the adsorption, in Faraday (F), A is the area of the capacitor plate 320 or 322, in m², ε₀ is the permittivity of free space, in F/m, and Δε is the change in dielectric constant of the dielectric 340 during adsorption.

Each of the water molecules 350 contributes to the total dipole moment. Therefore, the dielectric constant increases as the density of water molecules 350 increases, and decreases and the density of water molecule 350 decreases. The density of the water molecules 350 is the number of molecules per unit volume of the dielectric 340. Since the relative humidity is a function of the density of the water molecules 350, as the relative humidity increases, the density of water molecules increases, and decreases as the density of water molecules decreases. In other words, the capacitance of the capacitor 310 varies according to the moisture adsorption due to the relative humidity in the environment 215.

The capacitance circuit 320 provides a measurement of the capacitance of the capacitor 310 which in turn provides in-situ measurement of the moisture adsorption. In one embodiment, the capacitance circuit 320 may include terminals or connections to pads that are available for external connections so that a capacitance measurement circuit, e.g., in the data processing unit 240, may be connected externally. In another embodiment, it may include a converter to convert the capacitance to a signal varying according to the humidity level. The signal may be a current or a voltage that may be collected by the data processing unit 240.

The capacitance circuit 320 may be constructed using any known technique to measure the capacitance as is well known by one skilled in the art. A general method to measure capacitance includes measuring the total charge deposited on the capacitor. This may be performed by measuring the direct current (DC) currents, the frequency of the applied signals, and the voltage levels. The capacitance C may be determined from the following equation:
C=I/Vf (2)

where C is the capacitance in Farad (F), I is the current in Amperes (A), V is the voltage level in Volts (V) and f is the frequency of the signal in Hertz (Hz).

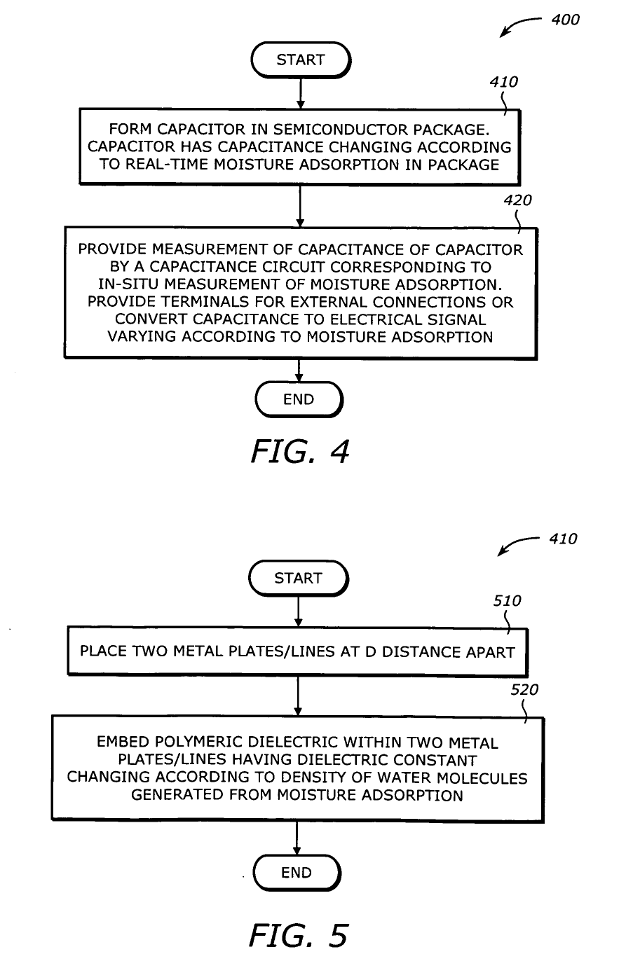

FIG. 4 is a flowchart illustrating a process 400 to sense moisture uptake according to one embodiment of the invention.

Upon START, the process 400 forms a capacitor in a semiconductor package (Block 410). The capacitor has a capacitance changing according to a real-time moisture adsorption in the package. The moisture adsorption is due to or corresponds to a humidity level surrounding the package. The capacitor may be located approximately at a corner or center of the package. Next, the process 400 provides measurement of the capacitance of the capacitor by a capacitance circuit corresponding to an in-situ measurement of the moisture adsorption (Block 420). This may be performed by providing external connections to a capacitance measuring circuit or measuring the capacitance internally. Measuring the capacitance internally may include converting the capacitance to a signal varying according to the moisture adsorption. The process 400 is then terminated.

FIG. 5 is a flowchart illustrating a process 410 shown in FIG. 4 to form a capacitor according to one embodiment of the invention.

Upon START, the process 410 places two metal plates or lines at a distance apart (Block 510). Next, the process 410 embeds a polymeric dielectric within the two metal plates or lines having a dielectric constant changing according to density of water molecules generated from the moisture adsorption (Block 520). The dielectric constant increases as the density of water molecules increases, and decreases as the density of the water molecules decreases. The two metal plates or lines may have approximately equal dimensions. The change in the capacitance varies according to the change in the dielectric constant. The process 410 is then terminated.

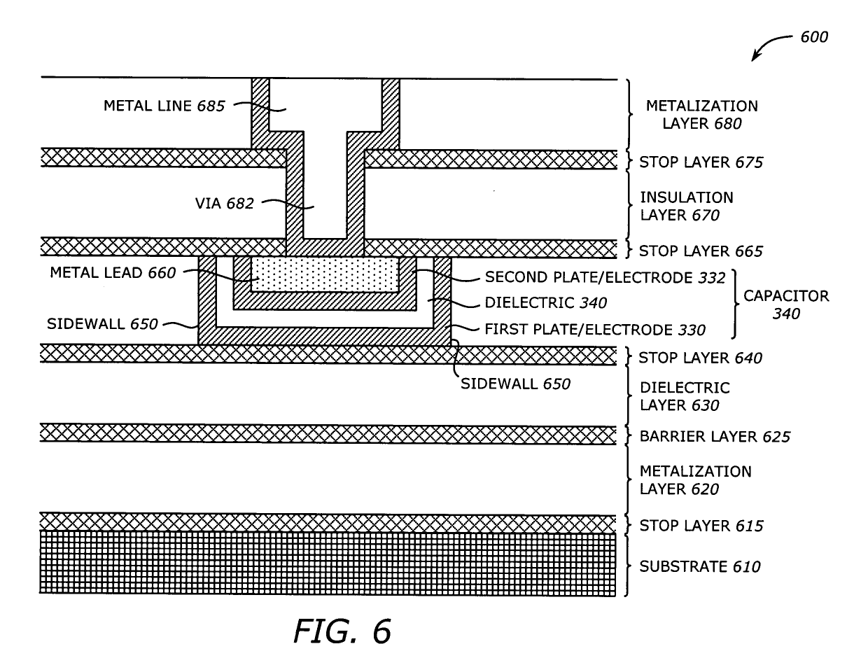

FIG. 6 is a diagram illustrating a circuit 600 having the capacitor 310 shown in FIG. 3 according to one embodiment of the invention. The circuit 600 illustrates an example of forming a capacitor during the wafer fabrication phase 105 shown in FIG. 1. The circuit 600 includes several layers or materials as needed for the construction of circuit elements in the die. The circuit 600 includes a substrate layer 610, stop layers 615, 640, 665, and 675, a metallization layer 620, a barrier layer 625, a dielectric layer 630, insulation layers 645 and 670, and a metallization layer 680.

The capacitor 310 may be fabricated in the insulation layer 645. The process may start with etching a recess or trench in the insulation layer 645 having two opposite sidewalls 650. Then, subsequent photo-resist, deposition, etching, and deposition (e.g., sputter or chemical vapor deposition) create the first plate/electrode 330. The first plate may include refractory metal or metal alloy (e.g., tantalum, titanium and/or their corresponding nitrides). Then, a dielectric layer 340 may be deposited on the metal layer of the first plate 330. Then, another metal layer may be deposited on the dielectric layer 340 to form the second plate/electrode 332. A metal lead layer may then be formed on the second plate/electrode 332. These layers are subsequently etched to form the desired capacitor 310.

The metal line 685 and the via 682 belong to a circuit component that may be formed on the capacitor 310. Metal lines may be formed to connect the two plates/electrodes to a capacitance circuit (not shown) which may include connection pads or a capacitance measuring circuit.

The circuit 600 merely provides an example of fabricating a capacitor internally to a die. Any other techniques to form a capacitor may be employed including the use of embedded passive (EP) technology. Since metal lines are available in any device circuits, the fabrication of a capacitor embedded in the die may be performed with few additional or extra steps.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
a capacitor formed in a semiconductor package having a capacitance changing according to a real-time moisture adsorption in the package; and
a capacitance circuit coupled to the capacitor to provide measurement of the capacitance of the capacitor corresponding to an in-situ measurement of the moisture adsorption.

2. The apparatus of claim 1 wherein the capacitor comprises:
two metal plates or lines placed at a distance apart; and
a polymeric dielectric embedded within the two metal plates or lines having a dielectric constant changing according to density of water molecules generated from the moisture adsorption.

3. The apparatus of claim 1 wherein the capacitance circuit comprises:
terminals for external connections.

4. The apparatus of claim 1 wherein the capacitance circuit comprises:
a converter to convert the capacitance to a signal varying according to the humidity level.

5. The apparatus of claim 2 wherein the dielectric constant increases as the density of water molecules increases.

6. The apparatus of claim 2 wherein the two metal plates or lines have approximately equal dimensions.

7. The apparatus of claim 2 wherein the capacitor is located approximately at a corner or center of the package.

8. A method comprising:
forming a capacitor in a semiconductor package, the capacitor having a capacitance changing according to a real-time moisture adsorption in the package; and
providing measurement of the capacitance of the capacitor corresponding to an in-situ measurement of the moisture adsorption.

9. The method of claim 8 wherein forming the capacitor comprises:
placing two metal plates or lines at a distance apart; and
embedding a polymeric dielectric within the two metal plates or lines having a dielectric constant changing according to density of water molecules generated from the moisture adsorption.

10. The method of claim 8 wherein providing measurement of the capacitance comprises:
providing terminals for external connections.

11. The method of claim 8 wherein providing measurement of the capacitance comprises:
converting the capacitance to a signal varying according to the humidity level.

12. The method of claim 9 wherein the dielectric constant increases as the density of water molecules increases.

13. The method of claim 9 wherein placing two metal plates or lines comprises placing the two metal plates or lines having approximately equal dimensions.

14. The method of claim 9 wherein forming the capacitor comprises forming the capacitor located approximately at a corner or center of the package.

15. A system comprising:
a moisture chamber to generate a humidity level; and
a semiconductor package placed in the moisture chamber subject to a stress test, the package having a humidity sensor, the humidity sensor comprising:
a capacitor having a capacitance changing according to a real-time moisture adsorption in the package, and
a capacitance circuit coupled to the capacitor to provide measurement of the capacitance of the capacitor corresponding to an in-situ measurement of the moisture adsorption.

16. The system of claim 15 wherein the capacitor comprises:
two metal plates or lines positioned at a distance apart; and
a polymeric dielectric embedded within the two metal plates or lines having a dielectric constant changing according to density of water molecules generated from the moisture adsorption.

17. The system of claim 15 wherein the capacitance circuit comprises:
terminals for external connections.

18. The system of claim 15 wherein the capacitance circuit comprises:
a converter to convert the capacitance to a signal varying according to the humidity level.

19. The system of claim 16 wherein the dielectric constant increases as the density of water molecules increases.

20. The system of claim 16 wherein the two metal plates or lines have approximately equal dimensions.
